(19) United States
(12) Patent Application Publication
(10) Pub. No.: US 2001/0039529 A1
(43) Pub. Date: Nov. 8, 2001

(54) System and process for requesting a quotation

(76) Inventor: Roger P. Hoffman, Green Bay, WI (US)

Correspondence Address: Weiss & Weiss / Philip M. Weiss, Suite 305, 500 Old Country Road, Garden City, NY, 11530, US

(21) Appl. No.: 09/755,488

(22) Filed: Jan. 5, 2001

Related U.S. Application Data
(60) Provisional application No. 60/175,096, filed on Jan. 7, 2000.

(51) Int. Cl. G06F 17/60

(52) U.S. Cl. 705/37

(57) ABSTRACT

The present invention relates to a system and method for requesting a quotation.

### BACKGROUND OF THE INVENTION

In the world of business, a buyer requests a quotation from a particular seller about buying a product from the seller. Based on the specifications provided by the buyer to the seller about the product, which include, quantity, shipping date, method of shipment and other characteristics, the seller provides a quotation to the buyer.

Over the Internet, most transactions are conducted between a consumer and a company providing a product to a consumer. A consumer usually chooses a product from a catalog and then purchases the product with a credit card. The product is then shipped by the company to the consumer.

There is nothing presently on the Internet which will allow a business to business transaction, where the payment is not simply a credit card. With a business to business transaction, many transactions do not involve a catalog or set of prices. Many times a buyer will provide a quotation with specifications regarding the product, quantity and method of shipment. In the past these quotations were provided to businesses whom the buyer had done business previously and knew could fulfill the order. With the advent of the Internet, a new system must be developed to expand the request for quotation bids.

### SUMMARY OF THE INVENTION

The present invention relates to a system and method for requesting a quotation. The present invention relates to a method for a buyer to request a quotation comprising; inputting or choosing: attributes of a specific product into a database, the quantity of product, and delivery specifications, selecting suppliers to submit the request for quotation, and submitting the request for quotation to the suppliers. It is an object of the invention for the quotation to be submitted to the suppliers via a wireless method. It is an object of the present invention to provide freight quotes to the supplier. It is an object of the invention for the supplier to provide a response to the buyer. It is an object of the present invention for the supplier to provide a response to the buyer via a wireless method. It is an object of the present invention for the quotation to have an expiration mechanism. It is an object of the present invention to compare the quotation from one supplier to quotations from other suppliers. It is an object of the present invention to provide the buyer a way for rating the quotes from different buyers and then to compare the ratings.

The present invention relates to a system for a buyer to request a quotation comprising; a database having a request for quotation form, the request for quotation form comprising a list of product specifications, and delivery specifications, and a means for delivering the quotation form to a seller. It is an object of the present invention for the system to have an expiration mechanism. It is an object of the present invention for the database to have a list of suppliers for a specific product. It is an object of the present invention for the system to have a logistics database for providing freight quotes. It is an object of the present invention for the system to have a calendar and a reminder system. It is an object of the present invention for the database to store quotations from sellers and allow a user to compare the quotations. It is an object of the present invention for the system to have a secured chat room. It is an object of the present invention for the system to perform a credit check of a buyer. It is an object of the present invention for the system to provide a database of buyer credit profiles.

It is an object of the present invention that when a user inputs a product, a list of product specifications will be presented to the user for the user to choose from. The buyer inputs the quantity of the product that they are seeking and the required date of delivery. A list of suppliers that can fulfill the request made by the buyer is then presented to the buyer. The buyer can provide the RFQ to the potential sellers by a number of different means. It is an object of the present invention that the buyer can e-mail to each of the sellers the request for quotation. It is an object of the present invention to provide that RFQ to the potential sellers via wireless methods. How long it takes for each seller to respond to a request for a quotation is a feature of the present invention. It is an object of the present invention for the RFQ to have an automatic expiration mechanism. It is an object of the present invention to remind a seller that they have not responded to an RFQ in their inbox. The seller can either respond to the buyer via e-mail or other standard methods of response.

It is an object of the present invention to provide a purchase order acknowledgment from the seller to the buyer. It is an object of the present invention to allow a buyer to make changes to the purchase order once they have received the purchase order acknowledgment.

A further objective of the present invention is to provide a means of establishing credit. The database can establish minimum credit worthiness. Buyers can establish the suppliers they wish to deal with and vice versa. Buyers can research and identify the suppliers. It is an object of the present invention for the present invention to provide a background check of a buyer. It is an object of the present invention to provide a credit check of the buyers. It is an object of the present invention to provide a list of credit references of each buyer.

It is an object of the present invention to allow a buyer to request a sample from a seller. It is an object of the present invention to inform a seller if a sample of a product can be provided to a seller and provide information to the seller about the sample and when it will be delivered.

A further object of the present invention is to provide a means for brokers to act as selling agents for companies who do not want to sell to any buyer directly.

A further object of the present invention is to provide a glossary; standard format data on a wide variety of product attributes and an industry - specific search engine.

### Brief Description of the Drawings

FIG. 1 illustrates an example of a Request for Quotation flow chart.

FIG. 2 illustrates an example of a Request for Quotation flow chart.

FIG. 3 illustrates an example of a Request for Quotation flow chart.

FIG. 4 illustrates an example of a Request for Quotation flow chart.

FIG. 5 illustrates an example of a Sample flow chart.

FIG. 6 illustrates an example of a Procurement flow chart.

FIG. 7 illustrates an example of a Delivery flow chart.

FIG. 8 illustrates an example of a Receiving flow chart.

### DETAILED DESCRIPTION OF THE INVENTION

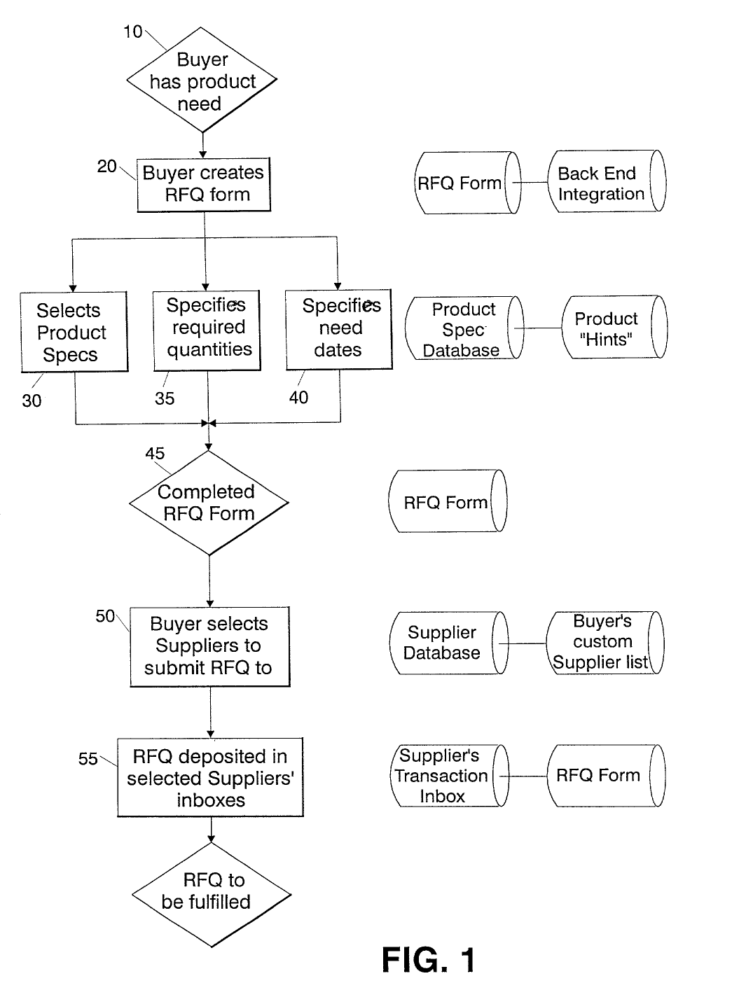

FIG. 1 illustrates an example of a Request for Quotation (RFQ) flow chart where a buyer creates and submits an RFQ. A buyer has a need for a specific product 10. The buyer creates an RFQ form 20. The buyer in the RFQ selects product specifications 30. In a preferred embodiment, the buyer can choose the type of product that they are requesting a quotation on and a list of product specifications will be presented to assist the user. In a preferred embodiment the buyer also provides the quantities of products needed 35 and the required dates of delivery 40. The buyer then completes the RFQ form 45 and then selects the suppliers to submit the RFQ to 50. In a preferred embodiment, the present invention will provide a list of potential suppliers who can supply the product requested based on the specifications of the buyer. In a preferred embodiment, the RFQ is submitted to a supplier's inbox or by a wireless method 55.

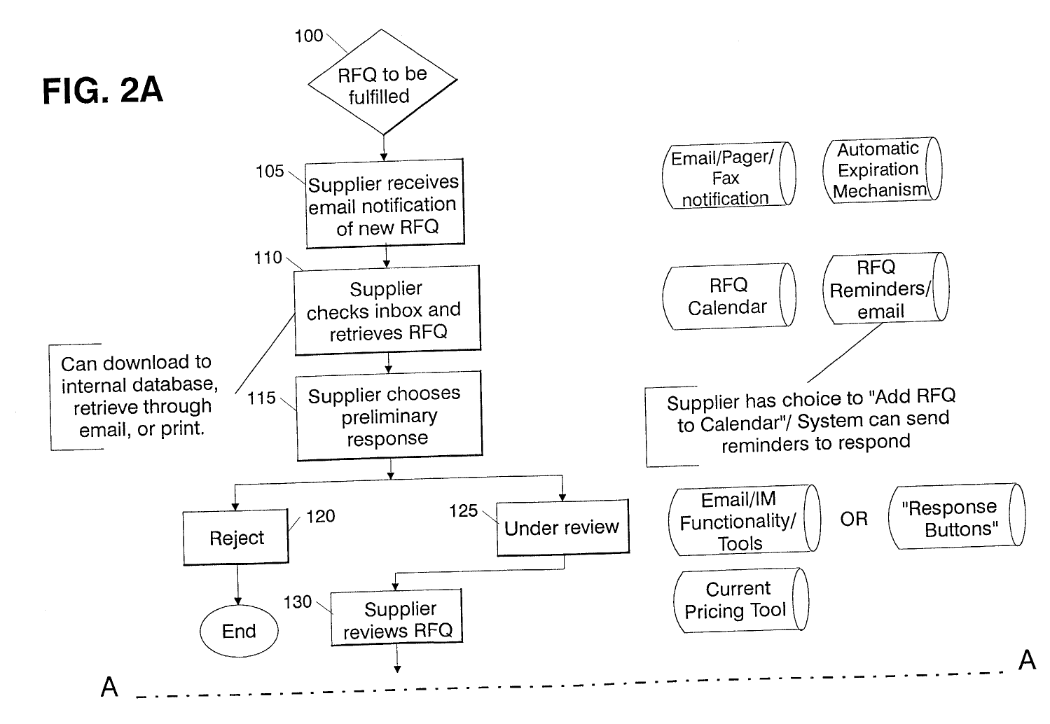

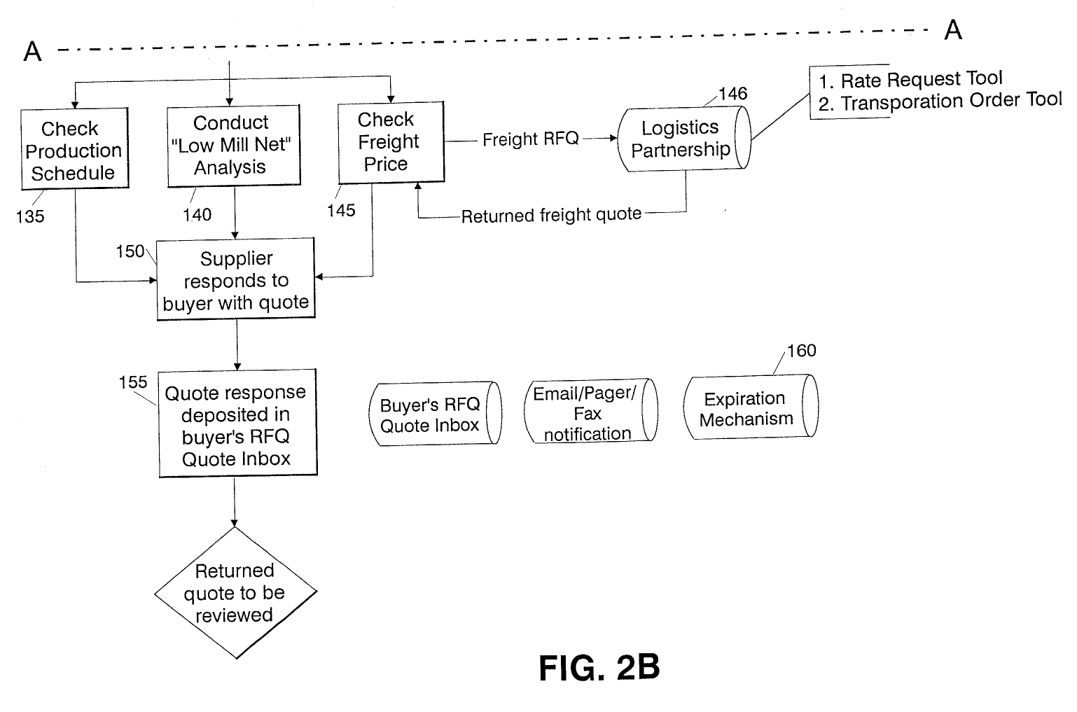

FIG. 2 illustrates an example of a Request for Quotation (RFQ) flow chart where a supplier reviews a buyer's RFQ. The RFQ is submitted to a seller 100. In a preferred embodiment the seller receives an e-mail notification of a new RFQ 105, however, the seller could be notified by other means including wireless methods. The seller checks their inbox and retrieves the RFQ 110. In a preferred embodiment, the seller can either download the RFQ to an internal database, retrieve the RFQ through an email or print. The supplier chooses a preliminary response 115 either a rejection 120 or under review 125. If the seller rejects the RFQ, the process ends. If the seller chooses to review the RFQ 130 the seller has a number of options. For example, the seller can check their production schedule 135, conduct a “Low Mill Net” Analysis 140 and the seller can review a database where freight charges are analyzed 145. In a preferred embodiment, the system can be connected with a logistics partner 146 to assist in providing freight quotes. The seller then supplies a response to the buyer with a quote 150. In a preferred embodiment, the quote response is deposited in a buyer's RFQ Quote inbox 155. In a preferred embodiment, a buyer can be notified of a Quote by email, pager or facsimile notification. In a preferred embodiment, the Quote has a time limit in which the Quote is good 160, i.e., an Expiration Mechanism. If the buyer does not respond to the Quotation within a certain time the Quotation can not be responded to. In a preferred embodiment, the system of the present invention has an RFQ calendar 170, and reminder system, to remind a supplier to respond to an RFQ that has been sent to them.

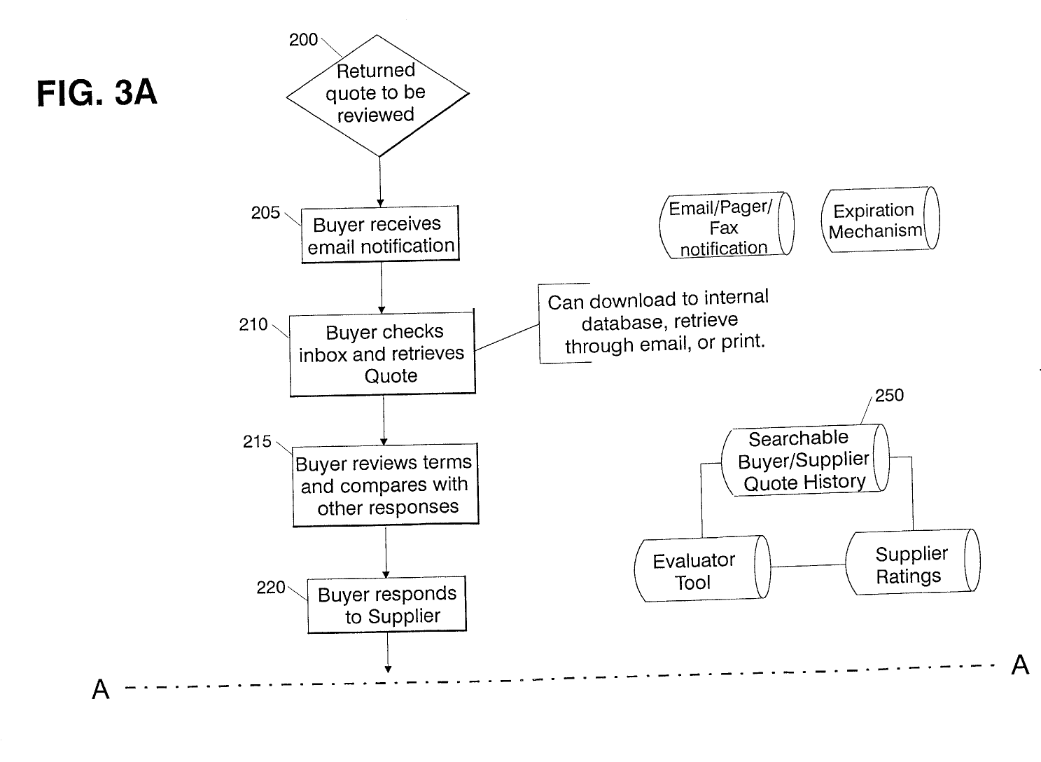

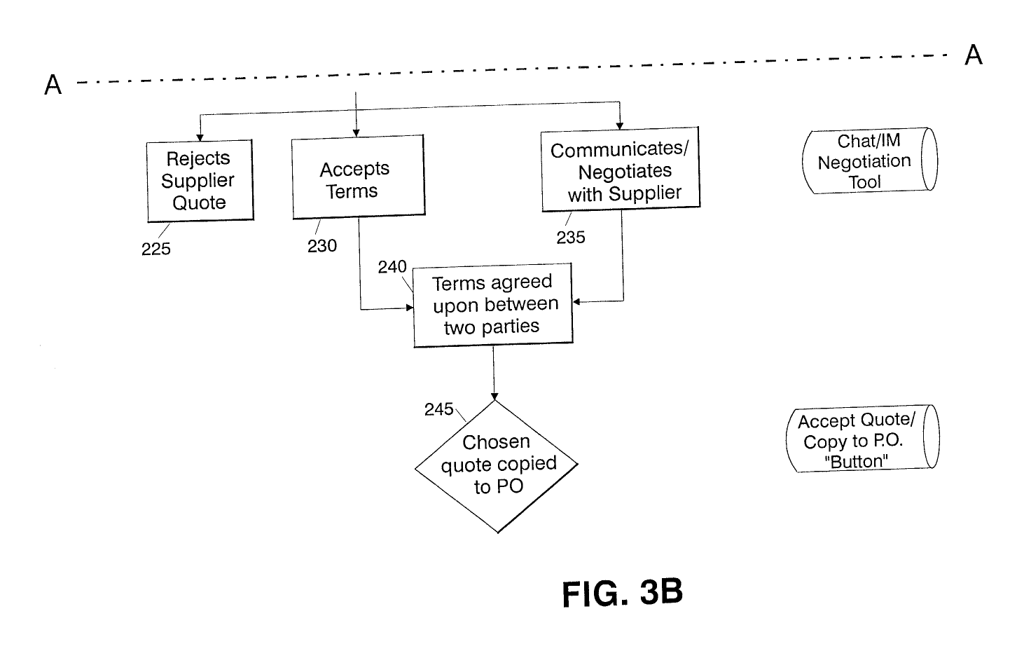

FIG. 3 illustrates an example of a Request for Quotation (RFQ) flow chart where a supplier supplies a quote to a buyer. A seller sends a quote to a buyer for their review 200. A buyer receives a notification that a seller has submitted a quotation to the buyer 205 . In a preferred embodiment, the buyer is notified by email or a wireless means, facsimile, or pager. The buyer checks their inbox and retrieves the Quote 210. In a preferred embodiment, the buyer can download the quote to an internal database, retrieve through email or print. The buyer can retrieve the terms of the Quote and compare them through the database of the present invention to other quotes that the buyer has received 215. The buyer can respond to the sellers in a number of ways 220. The buyer can reject the seller's quote 225. The buyer can accept the terms of the seller 230. The buyer can negotiate with any one of the sellers 235. In a preferred embodiment, the buyer can negotiate with the seller through a secured chat room. The terms are then agreed upon between a buyer and seller 240. The quote is then copied into a purchase order 245. In a preferred embodiment, once a quote is accepted all of the other sellers are notified that a quote has been accepted. In a preferred embodiment, the system of the present invention can provide an anonymous listing of previous sales so that the buyer and seller can compare these to previous quotes. The system of the present invention can provide a searchable buyer/seller quote history 250.

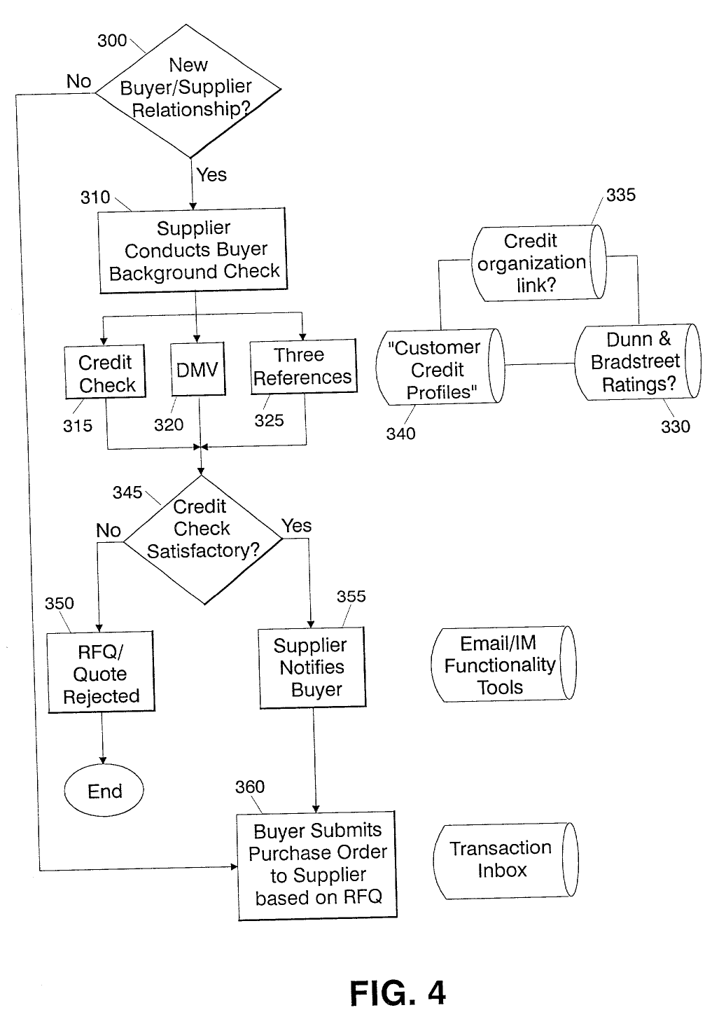

FIG. 4 illustrates an example of a Request for Quote (RFQ) where there is a new relationship between the buyer and seller 300. When a seller receives a request for a quotation from a buyer with which he has not done business with previously, the seller conducts a background check of the buyer 310. In a preferred embodiment, the present invention will allow the seller to perform a credit check 315, DMV 320, or allow the buyer to have on file a list of references to produce to the seller 325. For instance, the system of the present invention can do a Dun & Bradstreet Rallings credit check 330 or the system can have a different credit organization link 335. In a preferred embodiment, the system of the present invention has a database of buyer credit profiles 340. If the credit check 345 is unsatisfactory, then the RFQ quote is rejected 350. If the credit check is satisfactory, then the seller notifies the buyer 355 and the buyer submits the purchase order to the supplier based on the RFQ 360.

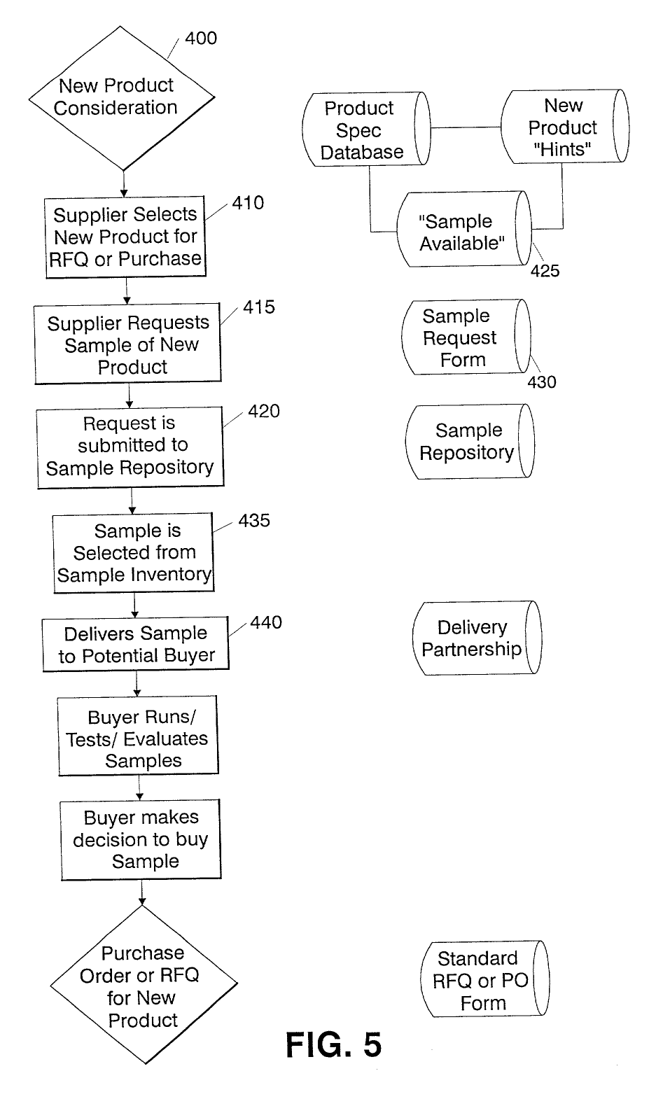

FIG. 5 illustrates an example of a Sample flow chart. A seller wants to place a new product before a buyer 400. The supplier selects the new product for the RFQ or purchase 410. In a preferred embodiment, a buyer can request a sample of a product before purchasing the product. The supplier requests a sample of the new product 415. The request is then submitted to a sample repository 420. When a buyer requests a certain product, the system of the present invention can tell the seller that a sample of this product can be provided to the buyer. The database of the present invention determines if a sample is available 425. In a preferred embodiment, the system of the present invention provides a sample request form 430. If a sample is available the sample is selected from the sample inventory 435. The seller can then respond with a delivery schedule of when a sample will be delivered to a buyer and the sample is delivered to the buyer 440. After receiving and testing a sample, a buyer can use the system as described to purchase a product.

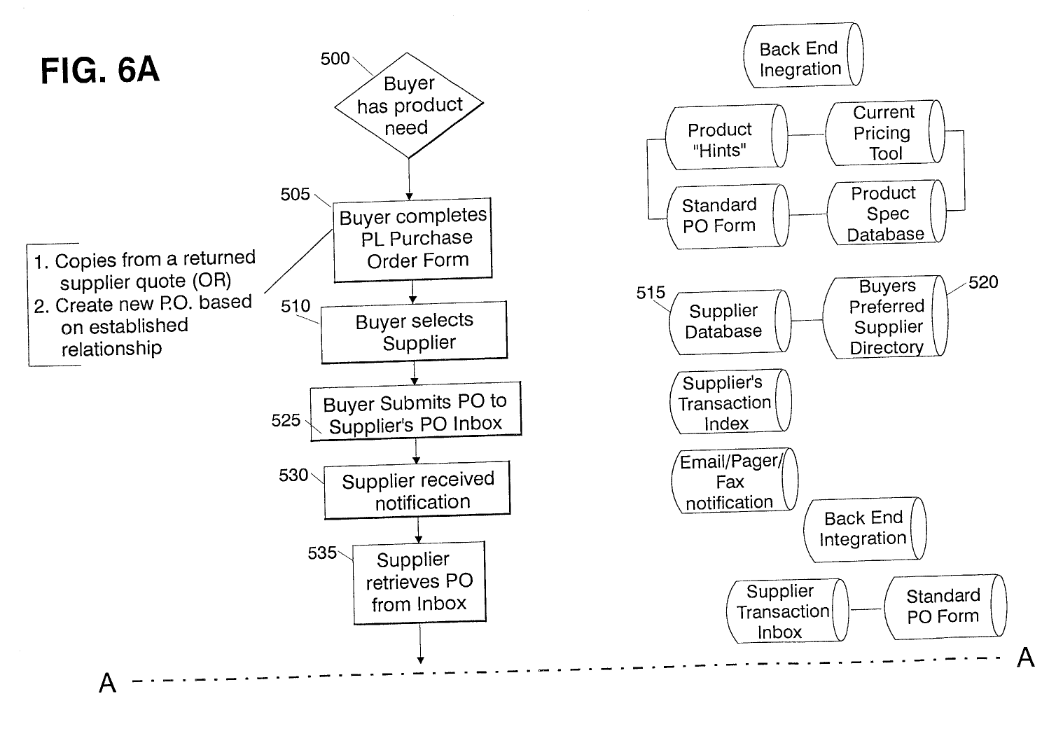

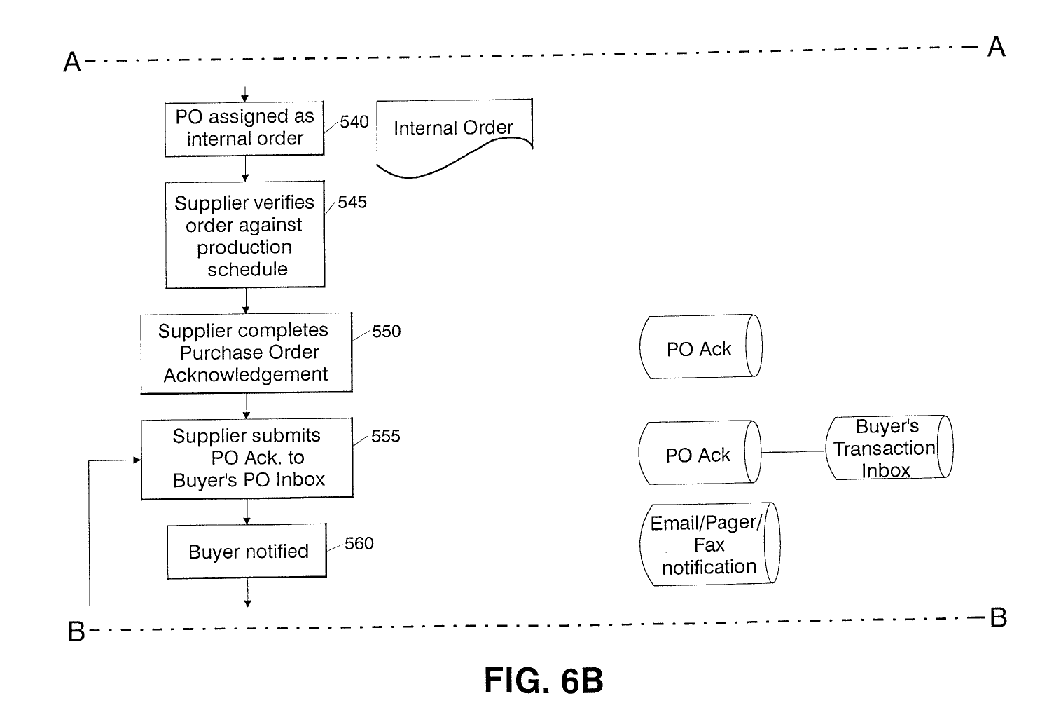

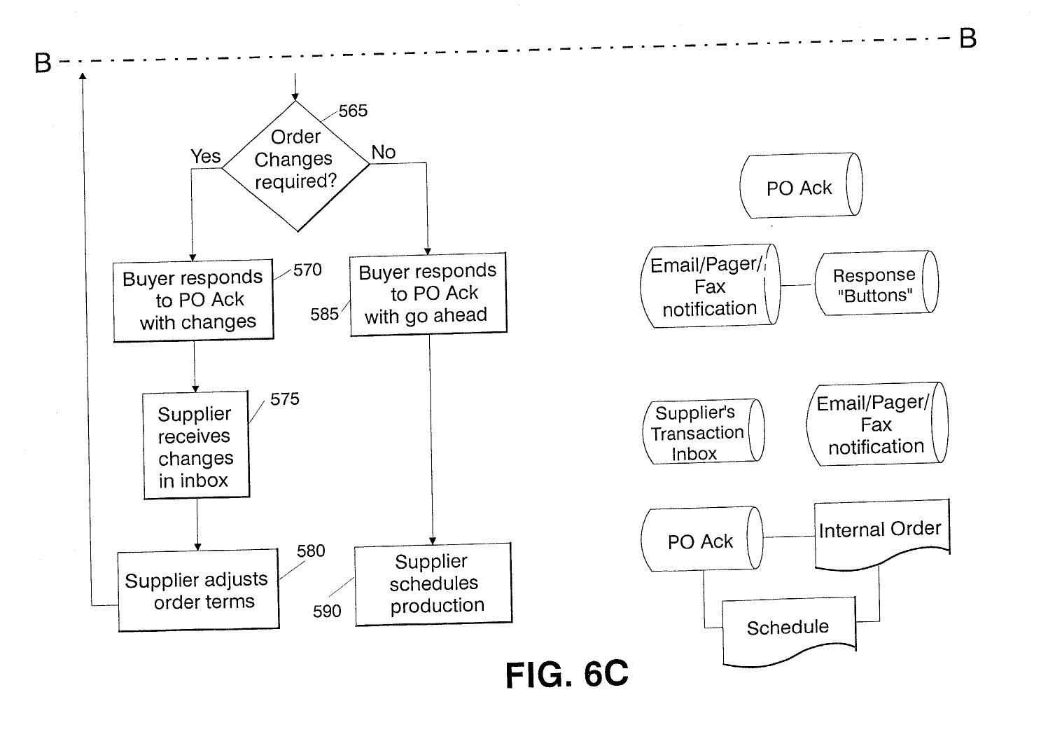

FIG. 6 illustrates an example of a Procurement flow chart. A buyer has a product need 500. A buyer completes a purchase order form 505 In an embodiment, a buyer copies a returned supplier quote (OR) or a buyer creates a new purchase order based on an established relationship. A buyer then selects a supplier 510 from the supplier database 515 or in another embodiment from the particular buyer's preferred supplier directory 520. A buyer submits a purchase order to a supplier's purchase order inbox 525. The supplier receives notification of the purchase order via e-mail, pager or facsimile 530. The supplier receives the purchase order from their inbox 535. The purchase order is assigned as an internal order 540. The supplier verifies their order against their production schedule 545. The supplier completes a purchase order acknowledgment 550. The supplier submits the purchase order acknowledgment to the inbox of the buyer 555. The buyer is then notified of the acknowledgment 560. The buyer can be notified, for example, by email, fax or pager. The buyer then determines whether any changes to the order are required 565. If changes are required, then the buyer responds to the purchase order and requests changes 570. The supplier receives the changes in their inbox 575. The supplier then adjusts the order terms 580 and then submits the purchase order to the buyer's purchase order inbox 555. If the buyer has no changes to the purchase order, the buyer can then tell the supplier to go ahead with the purchase order 585. The supplier can then adjust their schedule based on the purchase order 590.

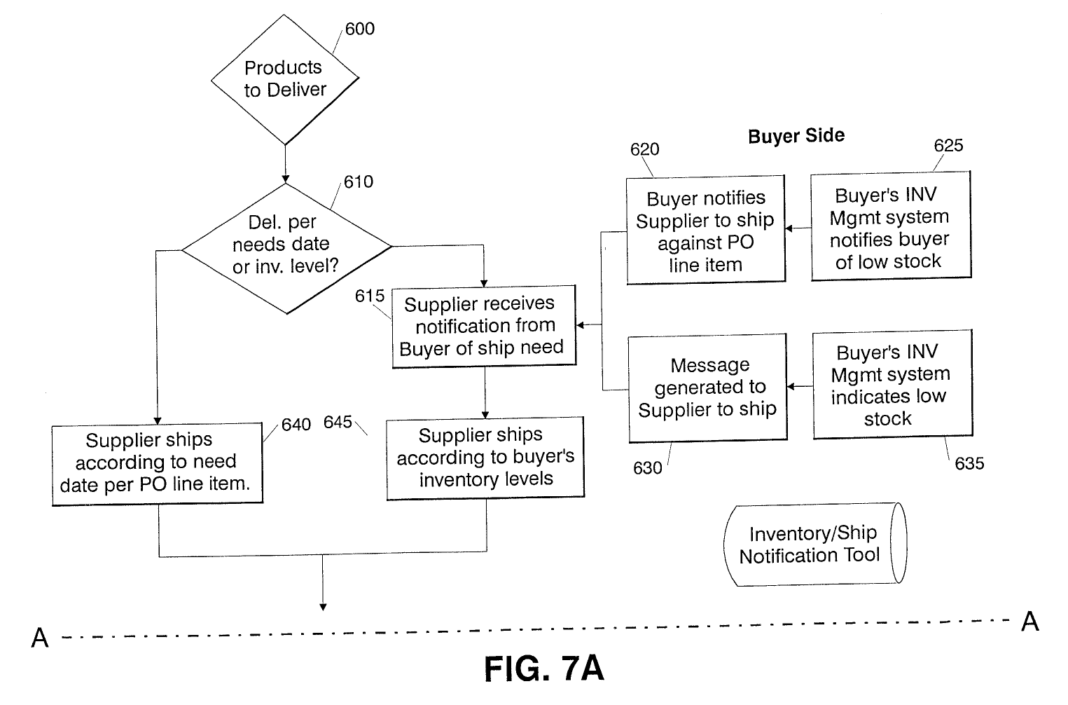

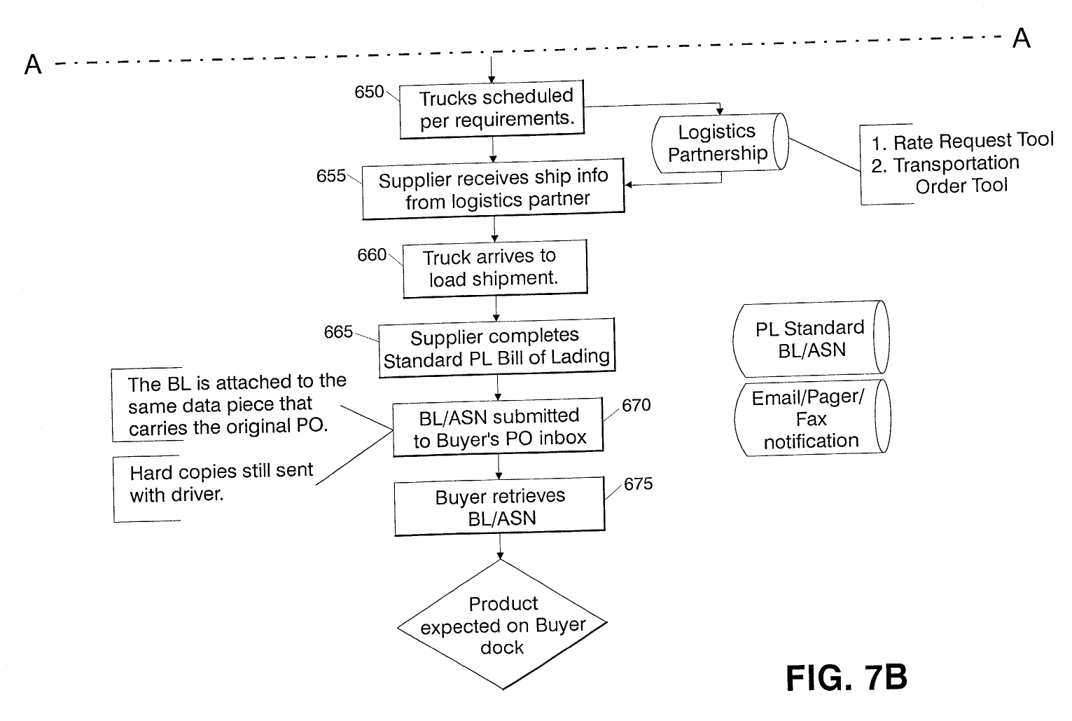

FIG. 7 illustrates an example of a Delivery flow chart. An order is placed for delivery 600. Delivery can either be based on a date of delivery or an inventory level 610. A supplier receives a notification from a buyer of the need for a shipment 615. A buyer's invoice management system notifies a buyer of a low stock amount 625. The buyer notifies the supplier to ship against a purchase order line item 620. In another embodiment, the buyer's inventory management system indicates a low stock 635, a message is generated to a supplier to ship 630. A supplier then ships either according to a need date per purchase order line item 640 or according to the buyer's inventory levels 645. In an embodiment, trucks are scheduled according to requirements 650. A supplier receives information from a logistics partner 655. The truck arrives to load the shipment 660. The supplier completes the Standard PL Bill of Lading 665. The BL/ASN is submitted to a buyer's PO inbox 670. The BL can be attached to the same data piece that carries the original PO or hard copies can be sent with the driver. The buyer retrieves the BL/ASN 675.

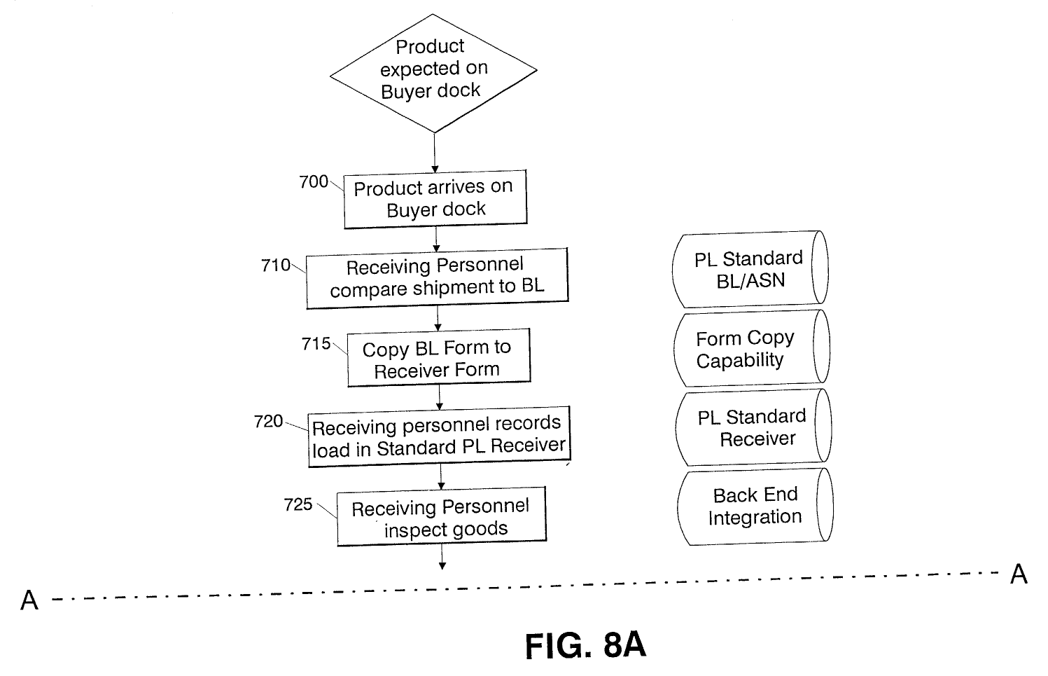

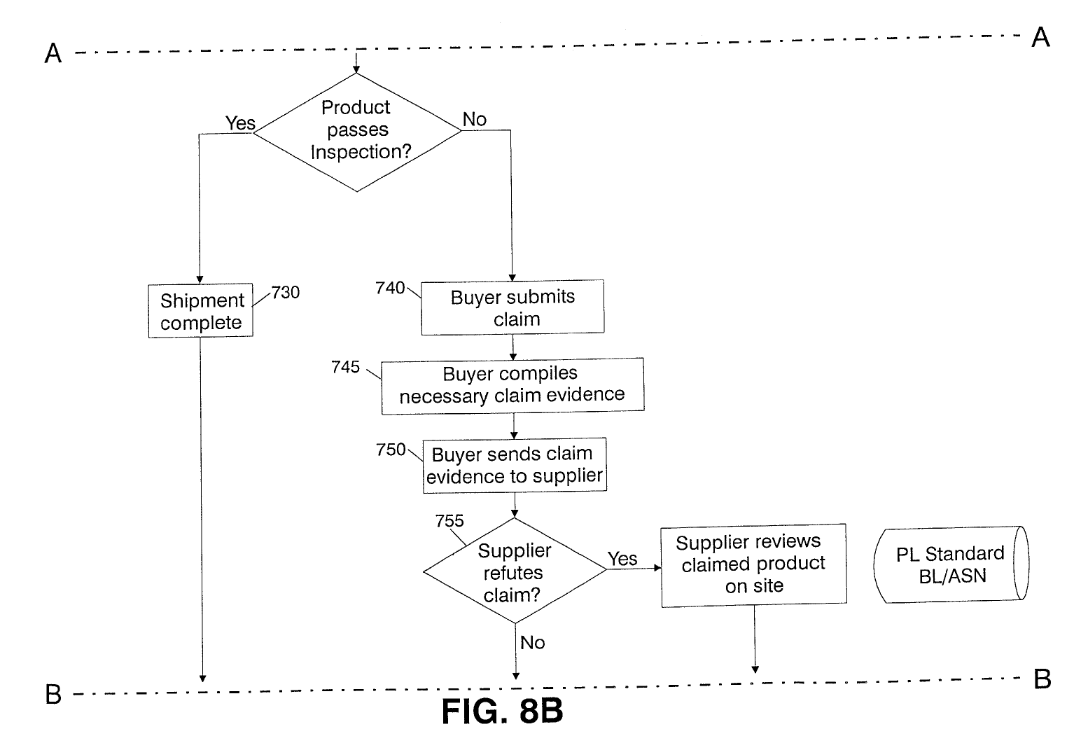

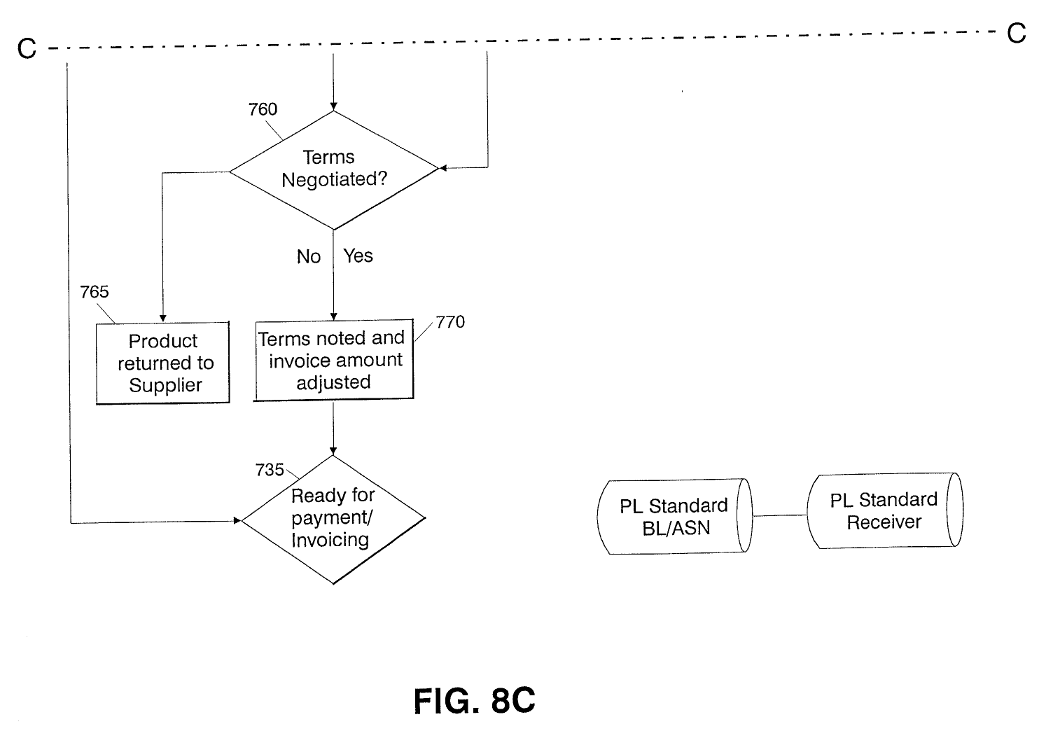

FIG. 8 is an example of a Receiving flow chart. The buyer receives the products at their location 700. The products are compared to the order 710. The buyer copies the BL form to the receiver form 715. The buyer receives personnel records loaded into a standard PL Receiver 720. The goods are inspected by the buyer 725. If the product passes inspection 730, the goods are ready for payment and invoicing 735. If the goods do not pass inspection, then the buyer submits a claim 740. The buyer compiles the necessary evidence for the claim 745. The buyer then sends the evidence to the supplier 750. The seller can then either refute the claim 755 or negotiate terms 760. If the buyer and seller can not negotiate terms, then the products are returned 765. If the buyer and seller negotiate terms, then the invoice amount is adjusted 770. At this time the goods are ready for payment and invoicing 735.

Below are some specific examples of how a transaction under the present invention can occur in an industry, such as the paper industry.

### EXAMPLE 1

Buyer X wishes to request a quotation for paper rolls. Buyer X types into the database all of the attributes that he wants for the paper rolls. Included in these attributes is the basis weight of the paper, the area of the country where X would like the rolls made, delivery time, method of delivery, etc. Although the buyer can type in all of the attributes that he wishes the product to have, a chart with all of the standard information which is required, such as delivery date, etc. can be provided in a chart form.

Oftentimes the buyers of products do not know the specific attributes that exist in the products that they purchase as they relate to their particular needs. For example, a printer may find that in some instances, paper purchased from two different suppliers varies in the amount of “showthrough”=a phenomenon whereby the printing is visible through the paper.

The buyer can enter “showthrough” and find the particular paper characteristics that influence showthrough such as “opacity.” The suppliers can all provide data on product attributes in a standard format such that the buyer can compare suppliers.

To help facilitate these types of purchasing decisions, the present invention in a preferred embodiment provides a glossary; standard format data on a wide variety of product attributes and an industry-specific search engine.

This document is then sent into a database which stores information provided by the suppliers or sellers of such goods. The information provided by the sellers is updated constantly, preferably monthly, and more preferably weekly or daily. The System compares the attributes requested by buyer X with the information stored in the database provided by the sellers. The system then provides a list of sellers to buyer X which can match the attributes requested by Buyer X. If no sellers can directly match the attributes that are requested by buyer X then the five or ten closest sellers are sent back to buyer X for analysis. The system is able to sort the attributes so that the buyer can understand what attributes the sellers can not provide.

Buyer X can then choose which sellers that he wishes to request a quotation from. The seller however, may not want to provide a quotation to the buyer. If the seller does not want to provide a quotation to buyer X, but a broker or middle man would provide a quotation to buyer X and be responsible for any credit risk, when the quote for such a seller is requested, the system will automatically refer the request for a quotation to a broker for this seller.

In a case where the seller does not know the specific buyer, but can find out the credit worthiness of the buyer, if the credit worthiness is not acceptable to the seller, buyer X can also be quoted from a broker who is willing to take the risk on buyer X paying.

1. A method for a buyer to request a quotation comprising;
inputting or choosing attributes of a specific product into a database;
inputting the quantity of product;
inputting delivery specifications;
selecting suppliers to submit said request for quotation;
submitting said request for quotation to said suppliers.

2. The method of claim 1 wherein said quotation is submitted to said suppliers via a wireless method.

3. The method of claim 1 further comprising said supplier analyzing said quotation with a logistics database to provide freight quotes.

4. The method of claim 1 wherein said supplier provides a response to said buyer.

5. The method of claim 4 wherein said supplier provides a response to said buyer via a wireless method.

6. The method of claim 1 wherein said quotation has an expiration mechanism.

7. The method of claim 4 further comprising;
comparing said quotation from said supplier to quotations from other suppliers

8. A system for a buyer to request a quotation comprising;
a database;
said database having a request for quotation form;
said request for quotation form comprising a list of product specifications, and
delivery specifications; and
a means for delivering said quotation form to a seller.

9. The system of claim 8 further comprising;
an expiration mechanism.

10. The system of claim 8 wherein said database has a list of suppliers for a specific product.

11. The system of claim 8 further comprising a logistics database for providing freight quotes.

12. The system of claim 8 further comprising a calendar and a reminder system.

13. The system of claim 8 wherein said database stores quotations from sellers;
said system allowing a user to compare said quotations.

14. The system of claim 8 further comprising a secured chat room.

15. The system of claim 8 further comprising;
a system for performing a credit check of a buyer.

16. The system of claim 8 further comprising;
a database of buyer credit profiles.

17. The system of claim 8 further comprising;
a database comprising a listing of previous sales.

18. The system of claim 8 further comprising;
a searchable database of buyer/seller quote history.
